(19) United States
(12) Patent Application Publication
(10) Pub. No.: US 2014/0324858 A1
(43) Pub. Date: Oct. 30, 2014

(54) INFORMATION PROCESSING APPARATUS, KEYWORD REGISTRATION METHOD, AND PROGRAM

(71) Applicant: SONY CORPORATION, Tokyo (JP)

(72) Inventor: Kenichiro KOBAYASHI, Kanagawa (JP)

(73) Assignee: SONY CORPORATION, Tokyo (JP)

(21) Appl. No.: 14/328,932

(22) Filed: Jul. 11, 2014

Related U.S. Application Data
(63) Continuation of application No. 13/012,183, filed on Jan. 24, 2011.

(30) Foreign Application Priority Data
Feb. 26, 2010 (JP) 2010-042721

(51) Int. Cl. G06F 17/30

(52) U.S. Cl. CPC G06F 17/30312
USPC 707/736

(57) ABSTRACT

An information processing apparatus according to the present invention includes a reception unit for receiving a predetermined trigger, a keyword estimation unit for estimating a keyword, desired to be registered by a user who transmits the trigger, in a content and metadata corresponding to the content provided in a predetermined period immediately before a time when the trigger is received, and a keyword registration unit for registering the keyword estimated by the keyword estimation unit.

### CROSS-REFERENCE TO RELATED APPLICATION PAPERS

This application is a continuation of U.S. application Ser. No. 13/012,183 filed Jan. 24, 2011, and claims priority to Japanese Patent Application JP 2010-042721 filed in the Japan Patent Office on Feb. 26, 2010, the entire contents of both of which are incorporated herein by reference.

### BACKGROUND OF THE INVENTION

1. Field of the Invention

The present invention relates to an information processing apparatus, a keyword registration method, and a program.

2. Description of the Related Art

For example, when a viewer watches a television program or a listener listens to a radio program, interesting information about a shop, a commodity, a sightseeing spot, and the like may be introduced in the program. In such a case, the viewer/listener is likely to take down a note using a pen and the like in order not to forget the provided information. However, it is difficult to instantly stop the program which the viewer is watching or listening to. Therefore, the viewer/listener may fail to write down the provided information.

Japanese Patent Application Laid-Open No. 2000-339345 discloses a technique about an apparatus for causing an internal memory to store a date/time when a user presses a button and allowing the user to later search broadcast information and music based on the stored date/time and location information registered in advance. When the user uses this apparatus, the user can easily later search interesting information provided in programs.

In a case where a television set has a temporary storage device for temporarily storing screens of television programs, the user may cause the temporary storage device to temporarily store a screen displaying interesting information, so that the user can later take time to take down a note about the interesting information.

### SUMMARY OF THE INVENTION

As described above, in the technique described in Japanese Patent Application Laid-Open No. 2000-339345, the internal memory temporarily records the date/time when the interesting information is provided, and it is necessary for the viewer/listener to later search information based on the recorded date/time. Even when the temporary storage device is arranged, the viewer has to take down a note about the interesting information. As described above, with the technique of the related art, it is not easy for the viewer/listener to take down a note about information provided in a program. Moreover, there is an issue in that it is cumbersome to search information.

In view of the foregoing, it is desirable to provide an information processing apparatus, a keyword registration method, and a program, which allow a viewer to easily take down a note about information provided in a content which the viewer is watching, thus improving the convenience of the viewer.

According to an embodiment of the present invention, there is provided an information processing apparatus including a reception unit for receiving a predetermined trigger, a keyword estimation unit for estimating a keyword, desired to be registered by a user who transmits the trigger, in a content and metadata corresponding to the content provided in a predetermined period immediately before a time when the trigger is received, and a keyword registration unit for registering the keyword estimated by the keyword estimation unit.

The keyword estimation unit preferably estimates the keyword in text data obtained by converting at least a portion of the content provided in the predetermined period into text, and the keyword registration unit preferably registers the keyword upon classifying the keyword according to an attribute of the keyword.

The information processing apparatus may further including an information-providing unit for providing the keyword to the user. The information-providing unit may provide the registered keyword in a data format prior to the conversion into text.

The information processing apparatus may further including an information-providing unit for providing the keyword to the user. The information-providing unit may provide the registered keyword in a text format.

The information processing apparatus may further including a management unit for managing the registered keyword. The management unit may search the registered keyword with a search condition according to an attribute of the keyword converted into text.

The predetermined trigger may be transmitted from a remote controller capable of communicating with the information processing apparatus.

The predetermined trigger may be a predetermined gesture performed by the user.

The information-providing unit may provide the registered keyword to the registration information display apparatus capable of mutually communicating with the information processing apparatus.

The keyword estimation unit may estimate the keyword by using at least one of a display screen of the content, audio data of the content, caption data included in the content, and EPG data corresponding to the content.

The keyword registration unit may register the keyword in association with at least one of a title, a genre of the content, a temporal position of the keyword with respect to a beginning of the content, and a date/time at which the content is provided.

The information processing apparatus may further including a related information obtaining unit for obtaining related information related to the estimated keyword. The related information obtaining unit may obtain, from an externally-arranged information search server, at least one of an address, a telephone number, position information about latitude and longitude, and date/time information related to the keyword, and the keyword registration unit may register the related information obtained by the related information obtaining unit in association with the keyword.

The related information obtaining unit may further obtain a URL of at least one of a homepage, a blog, word-of-mouth information, an RSS related to the keyword.

In a case where the registered keyword is associated with date/time information representing a date/time and where a difference between a current date/time and the date/time information is less than a predetermined threshold value, the information-providing unit may provide information indicating that the date/time associated with the registered keyword is approaching.

When the registration information display apparatus transmits position information representing a current position of the registration information display apparatus to the information-providing unit, the information-providing unit may provide the registration information display apparatus with a registered keyword associated with position information representing a position located within a predetermined range from the received position information representing the current position.

In a case where the registration information display apparatus transmits position information representing a current position of the registration information display apparatus to the information-providing unit and where the position indicated by the position information representing the current position is close to the position indicated by the position information associated with the registered keyword, the information-providing unit may automatically provide the registration information display apparatus with information about the registered keyword whose position information is coming into proximity.

The predetermined range can be set by the registration information display apparatus.

According to another embodiment of the present invention, there is provided a keyword registration method including the steps of receiving a predetermined trigger, estimating a keyword, desired to be registered by a user who transmits the trigger, in a content and metadata corresponding to the content provided in a predetermined period immediately before a time when the trigger is received, and registering the estimated keyword.

According to another embodiment of the present invention, there is provided a program for causing a computer to achieve a reception function for receiving a predetermined trigger, a keyword estimation function for estimating a keyword, desired to be registered by a user who transmits the trigger, in a content and metadata corresponding to the content provided in a predetermined period immediately before a time when the trigger is received, and a keyword registration function for registering the keyword estimated by the keyword estimation unit.

As described above, according to the present invention, the viewer can easily take down a note about the information provided in the content which the viewer is watching, and experience a higher degree of convenience.

### BRIEF DESCRIPTION OF THE DRAWINGS

FIG. 1 is an explanatory diagram illustrating an information processing system according to the first embodiment of the present invention;

FIG. 2 is a block diagram illustrating a configuration of the information processing apparatus according to the embodiment;

FIG. 3 is a block diagram illustrating a configuration of the information processing apparatus according to the embodiment;

FIG. 4 is a block diagram illustrating a configuration of the information processing apparatus according to the embodiment;

FIG. 5 is an explanatory diagram illustrating a confirmation screen showing a registration destination of a keyword;

FIG. 6 is an explanatory diagram illustrating a confirmation message for confirming keyword registration;

FIG. 7 is an explanatory diagram illustrating information stored in a buffer;

FIG. 8 is an explanatory diagram illustrating information stored in the buffer;

FIG. 9 is an explanatory diagram illustrating information stored in the buffer;

FIG. 10 is an explanatory diagram illustrating registration information according to the embodiment;

FIG. 11 is an explanatory diagram illustrating registration information according to the embodiment;

FIG. 12 is an explanatory diagram illustrating registration information according to the embodiment;

FIG. 13 is an explanatory diagram illustrating registration information according to the embodiment;

FIG. 14 is an explanatory diagram illustrating registration information according to the embodiment;

FIG. 15 is an explanatory diagram illustrating an example of a category selection screen according to the embodiment;

FIG. 16 is an explanatory diagram illustrating an example of a category selection screen according to the present embodiment.

FIG. 17 is an explanatory diagram illustrating an example of a display screen of a search result according to the embodiment;

FIG. 18 is a flow diagram illustrating a flow of a keyword registration method according to the embodiment;

FIG. 19A is a flow diagram illustrating a flow of a registration information-providing method according to the embodiment;

FIG. 19B is a flow diagram illustrating a flow of the registration information-providing method according to the embodiment; and

FIG. 20 is a block diagram illustrating a hardware configuration of an information processing apparatus according to an embodiment of the present invention.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The following explanation will be made in the order listed below.

(1) First Embodiment
(1-1) Information processing system
(1-2) Configuration of information processing apparatus
(1-3) Specific examples of keyword estimation processing, keyword registration processing, and registration information-providing processing
(1-4) Flow of keyword registration method
(1-5) Flow of registration information-providing processing

(2) Hardware configuration of information processing apparatus according to an embodiment of the present invention

(3) Summary

### First Embodiment

### <Information Processing System>

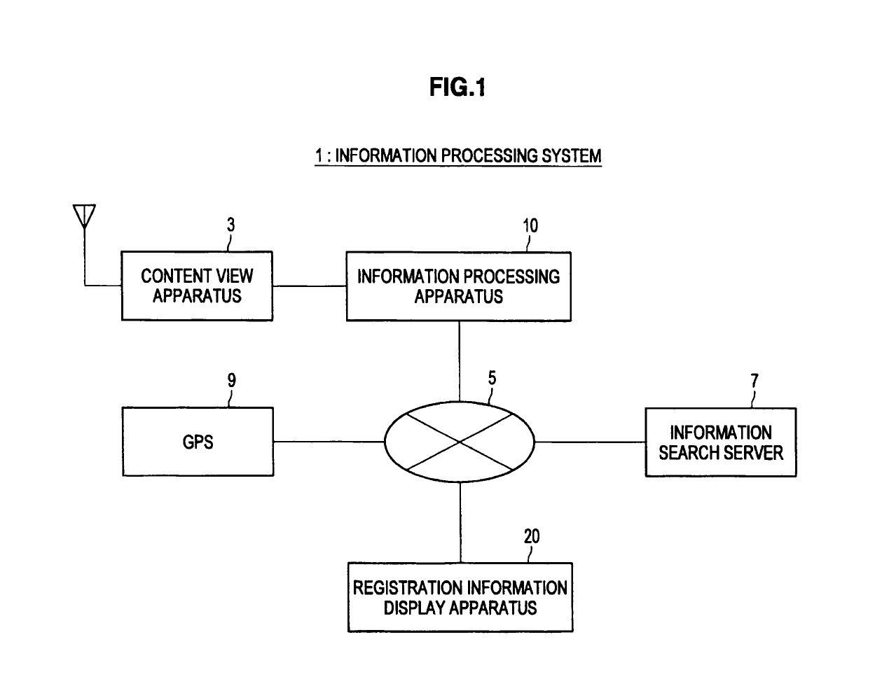

First, an information processing system 1 according to the first embodiment of the present invention will be explained with reference to FIG. 1. FIG. 1 is an explanatory diagram illustrating the information processing system 1 according to the present embodiment.

As shown in FIG. 1, the information processing system 1 according to the present embodiment includes a content view apparatus 3 and an information processing apparatus 10 connected to the content view apparatus 3. The information processing apparatus 10 can mutually communicate with a registration information display apparatus 20 via a network 5.

The information processing system 1 according to the present embodiment includes an information search server 7 and a GPS (Global Positioning System) 9 which are connected via the network 5. The information processing apparatus 10 and the registration information display apparatus 20 can mutually communicate with the server and the system.

The content view apparatus 3 is an apparatus capable of obtaining a content (program) such as TV broadcast, IPTV broadcast, and radio broadcast, and reproducing the obtained content. A user can find various kinds of information provided in a content upon viewing the content reproduced by the content view apparatus 3.

Examples of the content view apparatus 3 include a television set, various kinds of recorders such as a DVD recorder and a Blu-ray recorder, a personal computer, and a portable information terminal such as a portable telephone and a PDA.

The content view apparatus 3 can output entity data of the obtained content and various kinds of metadata associated with the entity data to the later-explained information processing apparatus 10.

The network 5 is a communication circuit network for allowing bidirectional communication between the information search server 7, the GPS 9, the information processing apparatus 10, and the registration information display apparatus 20. Examples of this network include public circuit networks such as the Internet, a telephone circuit network, a satellite communication network, and a simultaneous communication path, and dedicated circuit networks such as WAN (Wide Area Network), LAN (Local Area Network), IP-VPN (Internet Protocol-Virtual Private Network), Ethernet (registered trademark), and wireless LAN. This network may be connected either wirelessly or via a wire.

The information search server 7 is a server for managing a search engine or a database. The information processing apparatus 10 and the registration information display apparatus 20, which are explained later, use the information search server 7 to search and obtain related information related to a keyword.

The GPS 9 is a system used to identify a location on the earth based on signals transmitted from GPS satellites. The information processing apparatus 10 and the registration information display apparatus 20 can calculate position information representing a current position on the earth by receiving a plurality of signals transmitted from the GPS satellites. The information processing apparatus 10 and the registration information display apparatus 20 can achieve various kinds of functions and provide various kinds of functions to another apparatus by using the calculated position information.

The information processing apparatus 10 uses content data obtained from the content view apparatus 3 and metadata associated with the content data to estimate a keyword desired to be registered by the user in the content data and the metadata and register the estimated keyword. This registration processing of the keyword is started in response to a trigger that is given as a predetermined operation performed by the user who uses the content view apparatus 3.

The information processing apparatus 10 can obtain the related information related to the estimated keyword from the information search server 7 and the like via the network 5, and can record the related information in association with the keyword.

Further, the information processing apparatus 10 can provide information registered therein (registration information) to the registration information display apparatus 20.

The information processing apparatus 10 may obtain the content data and the metadata by itself instead of obtaining such data from the content view apparatus 3.

Examples of the information processing apparatus 10 include a television set, various kinds of recorders such as a DVD recorder and a Blu-ray recorder, and a personal computer. Alternatively, the information processing apparatus 10 may be a set top box connected to a television set and various kinds of recorders.

The information processing apparatus 10 will be explained in detail later.

The registration information display apparatus 20 is an apparatus capable of displaying registration information including a keyword and related information registered in the information processing apparatus 10. The registration information display apparatus 20 mutually communicates with the GPS 9 to obtain, from the GPS 9, position information representing a position at which the registration information display apparatus 20 is located and transmits the position information to the information processing apparatus 10.

The registration information display apparatus 20 may be any apparatus as long as it has an input function, an output function, and a communication function. Examples of such apparatuses include a personal computer, a portable information terminal such as a portable telephone and a PDA, and a car navigation system.

### <Configuration of Information Processing Apparatus>

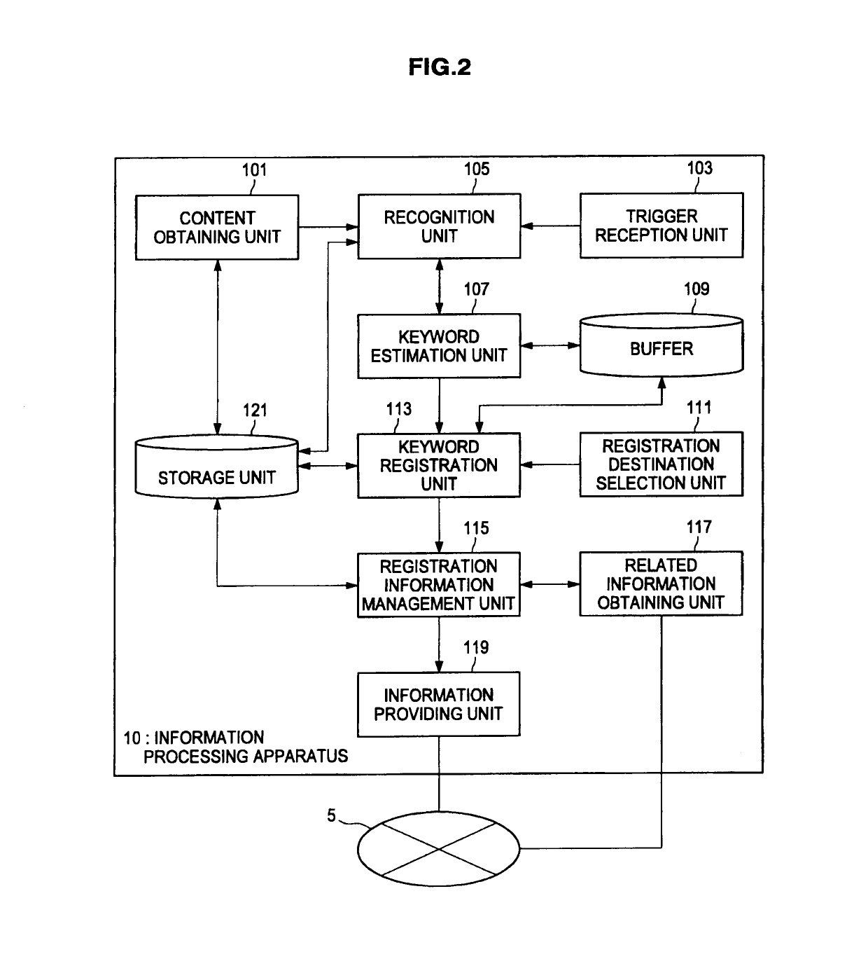

Subsequently, the configuration of the information processing apparatus 10 according to the present embodiment will be explained in detail with reference to FIGS. 2 to 4. FIGS. 2 to 4 are block diagrams illustrating the configuration of the information processing apparatus 10 according to the present embodiment.

For example, as shown in FIG. 2, the information processing apparatus 10 according to the present embodiment mainly includes a content obtaining unit 101, a trigger reception unit 103, a recognition unit 105, a keyword estimation unit 107, a buffer 109, a registration destination selection unit 111, a keyword registration unit 113, a registration information management unit 115, a related information obtaining unit 117, an information-providing unit 119, and a storage unit 121.

The content obtaining unit 101 is achieved with a CPU (Central Processing Unit), a ROM (Read Only Memory), a RAM (Random Access Memory), a communication unit, and the like. The content obtaining unit 101 obtains, e.g., entity data of various kinds of contents reproduced by the content view apparatus 3 (for example, various kinds of TV programs, radio programs, and contents distributed via network) and various kinds of metadata associated with the contents. The content obtaining unit 101 records the obtained data to the later-explained storage unit 121 for a predetermined period. Accordingly, each processing unit of the information processing apparatus 10 according to the present embodiment can retroactively perform various kinds of processing on these data when these programs and the like are actually reproduced.

Examples of metadata associated with contents include various kinds of data described in program information such as EPG (Electric Program Guide) and character information such as closed caption.

In addition, the content obtaining unit 101 may directly output the various kinds of obtained content data to the later-explained recognition unit 105.

The trigger reception unit 103 is achieved with, for example, a CPU, a ROM, a RAM, and the like. The trigger reception unit 103 can also obtain various kinds of signals from an audio input device such as a microphone and an image capturing device (not shown) such as a camera arranged in the information processing apparatus 10. The trigger reception unit 103 receives a trigger given as a predetermined operation performed by the user who uses the content view apparatus 3. This trigger is used to identify timing for starting execution of keyword estimation processing and keyword registration processing which are explained later.

Examples of predetermined operations performed by a user include pressing down a button arranged on, e.g., a remote controller of the content view apparatus 3 and performing a predetermined operation (for example, a gesture such as snapping fingers).

The user can use the remote controller of the content view apparatus 3 to easily find what kind of contents are reproduced by the content view apparatus 3. In a case where the remote controller has a function of obtaining a signal representing a program reproduced by the content view apparatus 3, the remote controller that is used by the user to transmit a trigger signal for giving an instruction of registration of a note may be a mobile terminal such as a portable telephone or may be a communication apparatus having a dedicated button.

When the trigger reception unit 103 receives a trigger given as a user operation as described above, the trigger reception unit 103 notifies the later-explained recognition unit 105 that the trigger reception unit 103 has received the trigger. The later-explained recognition unit 105 starts processing upon obtaining the notification. In other words, a series of operations for achieving the keyword estimation processing and the keyword registration processing is started.

The recognition unit 105 is achieved with, for example, a CPU, a ROM, a RAM, and the like. When the recognition unit 105 receives the notification that the trigger reception unit 103 has received the trigger from the trigger reception unit 103, the recognition unit 105 uses various kinds of analytic methods to analyze a content as well as metadata corresponding to the content which are provided in a predetermined period immediately before a date/time indicated by time information. The time information includes the date/time when the trigger was received. Therefore, the recognition unit 105 can recognize the content provided in the predetermined period immediately before the time indicated by the time information.

The predetermined period in which the recognition unit 105 performs various kinds of analyses may be a predetermined period such as 10 seconds, 20 seconds, 30 seconds, and the like, or may be a dynamic period up to when the later-explained keyword estimation unit 107 finds a keyword first.

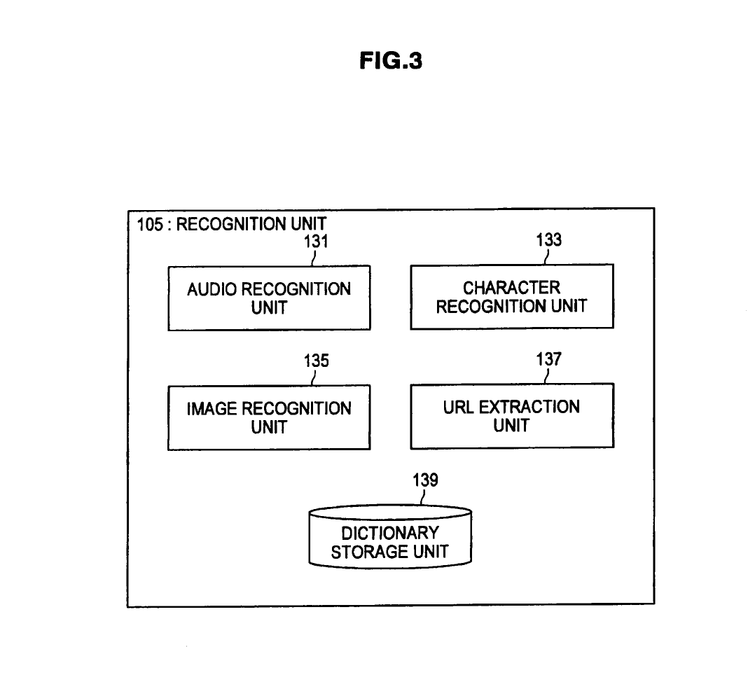

For example, as shown in FIG. 3, the recognition unit 105 further includes an audio recognition unit 131, a character recognition unit 133, an image recognition unit 135, a URL extraction unit 137, and a dictionary storage unit 139.

Each recognition unit as shown in FIG. 3 can independently operate to recognize a content and metadata associated with the content. Alternatively, each recognition unit may cooperate with each other to recognize the content and the metadata.

The audio recognition unit 131 is achieved with, for example, a CPU, a ROM, a RAM, and the like. The audio recognition unit 131 performs speech recognition on audio data included in content data obtained from the content obtaining unit 101 or the storage unit 121. Therefore, the audio recognition unit 131 can recognize speeches in the content (for example, conversation of performers and narrations in the program).

Various kinds of algorithms for speech recognition have been suggested. The audio recognition unit 131 can use any algorithm to perform speech recognition processing of audio data included in the content.

When the audio recognition unit 131 performs speech recognition processing of audio data, the audio recognition unit 131 can use, as necessary, various models such as an acoustic model and a language model and various kinds of dictionaries such as a pronunciation dictionary which are stored in the later-explained dictionary storage unit 139.

The audio recognition unit 131 outputs a recognition result of audio data to the later-explained keyword estimation unit 107. The audio recognition unit 131 may output not only text data representing the recognition result of the audio data but the audio data itself in association with data representing the recognition result.

The character recognition unit 133 is achieved with, for example, a CPU, a ROM, a RAM, and the like. The character recognition unit 133 extracts a content and character information included in metadata associated with the content and recognizes the content and the character information. At this occasion, the character recognition unit 133 uses various kinds of analytic methods such as morphological analysis, syntax analysis, and semantic analysis when the character recognition unit 133 recognizes the character information. Examples of character information included in contents include an open caption including various kinds of telops displayed on a reproduction screen of a content, characters described on a flip card held by a performer in a content, characters included in an image of a signboard of a shop, and characters described on a label of a merchandise such as a wine.

Various kinds of algorithms have been suggested to perform character recognition. The character recognition unit 133 can use any algorithm to perform character recognition processing on various kinds of character information included in the content.

When the character recognition unit 133 performs character recognition processing of character information, the character recognition unit 133 can use, as necessary, various kinds of dictionaries, databases, and the like stored in the later-explained dictionary storage unit 139.

The character recognition unit 133 outputs a recognition result of character information to the later-explained keyword estimation unit 107. The character recognition unit 133 may output not only text data representing the recognition result of the character information but the image data itself (for example, a certain scene in a program and the like) from which the character information has been extracted, in such a manner that the data is associated with data representing the recognition result.

The image recognition unit 135 is achieved with, for example, a CPU, a ROM, a RAM, and the like. The image recognition unit 135 performs image recognition processing on a playback screen of a content to recognize objects displayed on the playback screen.

Various kinds of algorithms for image recognition have been suggested. The image recognition unit 135 can use any algorithm to perform image recognition processing on the playback screen in the content.

When image recognition unit 135 performs image recognition processing of image information, the image recognition unit 135 can use, as necessary, various kinds of characteristic images and databases stored in the later-explained dictionary storage unit 139.

The image recognition unit 135 outputs a recognition result of image data to the later-explained keyword estimation unit 107. The image recognition unit 135 may output not only text data representing the recognition result of the image data but the image data itself in such a manner that the data is associated with data representing the recognition result.

The URL extraction unit 137 is achieved with, for example, a CPU, a ROM, a RAM, and the like. The URL extraction unit 137 extracts, from a content and metadata associated with the content, URLs (Uniform Resource Locators) included in these data. The URL extraction unit 137 independently analyzes and recognizes a content and metadata to extract information about URLs. The URL extraction unit 137 extracts the information about the URLs from recognition results provided by the audio recognition unit 131, the character recognition unit 133, and the image recognition unit 135.

The URL extraction unit 137 can extract not only the URLs (i.e., homepage addresses) but also E-mail addresses.

In this case, the URL extraction unit 137 can use any method as an algorithm for extracting URLs from a content, metadata corresponding to the content, and various kinds of recognition results. For example, the URL extraction unit 137 can extract URLs and E-mail addresses by finding characters and character strings peculiar to URLs and E-mail addresses such as “http://”, “www”, and “@ (at sign)”.

The URL extraction unit 137 outputs a URL extraction result to the later-explained keyword estimation unit 107. The URL extraction unit 137 may output not only text data representing the URL extraction result but the image data or the audio data itself from which the URLs have been extracted, in such a manner that the data is associated with data representing the extraction result.

The dictionary storage unit 139 is an example of a storage device arranged in the information processing apparatus 10 according to the present embodiment. The dictionary storage unit 139 stores various kinds of dictionary files and databases which can be used for various kinds of recognition processing and extraction processing which are performed by the audio recognition unit 131, the character recognition unit 133, the image recognition unit 135, and the URL extraction unit 137.

In this case, various kinds of dictionary files and databases stored in the dictionary storage unit 139 may be updated to reflect preferences of users based on keyword registration history information and the like. When such update processing is performed, keywords suitable of a preference of a user can be recognized in a more accurate manner, and further, the keywords suitable for the preference of the user can be estimated and registered in a more reliable manner.

Various kinds of dictionary files and databases stored in the dictionary storage unit 139 may be referenced by other processing units arranged in the information processing apparatus 10.

The configuration of the recognition unit 105 according to the present embodiment has been hereinabove explained in detail with reference to FIG. 3.

It should be noted that the recognition unit 105 does not need to have all the recognition units as shown in FIG. 3. The recognition unit 105 may execute content recognition processing using available recognition units as described above.

It is preferable for the recognition unit 105 to process not only main part of a certain content (such as a program content) but also commercial parts which are located between the main parts and are not related to the main part. This is because such commercial parts may include information which may be interesting to users, such as a new product and a ticket for a concert.

The configuration of the information processing apparatus 10 according to the present embodiment will be explained with reference back to FIG. 2.

The keyword estimation unit 107 is achieved with, for example, a CPU, a ROM, a RAM, and the like. The keyword estimation unit 107 estimates keywords, which are recognized by the recognition unit 105 and which are desired to be registered by a user who transmitted a trigger, in a content and metadata about the content provided in the predetermined period immediately before the reception of the trigger.

More specifically, the keyword estimation unit 107 estimates and extracts, as keywords desired to be registered by the user, various kinds of nouns such as a place name, a person's name, a product name, the name of a food, the name of a facility, and the name of an event, numerical strings such as a telephone number and a facsimile number, keywords related to the Internet such as a URL and an E-mail address of a homepage, and keywords such as a zip code and an address, from the recognition results provided by the recognition unit 105. In addition to the keywords listed above, the keyword estimation unit 107 can estimate and extract, for example, keywords about date/time limit (for example, a deadline for participating in giveaways and an on-sale date of a concert ticket).

Various kinds of methods have been suggested as methods for extracting keywords. The keyword estimation unit 107 can use any method to estimate and extract keywords desired to be registered by the user.

The keyword estimation unit 107 may continue the processing for estimating and extracting keywords from the recognition result output by the recognition unit 105 for a predetermined period (for example, the last 10 seconds from the time when the trigger is received). Alternatively, the keyword estimation unit 107 may start the keyword estimation/extraction processing when the trigger is received, and terminate the processing when a certain keyword is estimated and extracted for the first time.

When the keyword estimation unit 107 estimates and extract a certain keyword from the recognition result output from the recognition unit 105, the keyword estimation unit 107 stores the extracted keyword to the later-explained buffer 109. Alternatively, the keyword estimation unit 107 may directly output the extracted keyword to the keyword registration unit 113.

When the keyword estimation unit 107 finishes the keyword estimation processing and extraction processing, the keyword estimation unit 107 preferably notifies the recognition unit 105 that the processing is finished.

When the keyword estimation unit 107 executes keyword estimation and extraction processing, the keyword estimation unit 107 may reference various kinds of databases and dictionary files and extract keywords registered in the databases and the dictionary files. The keyword estimation unit 107 may use various kinds of databases and dictionary files to perform morphological analysis, syntax analysis, semantic analysis, and the like, on texts corresponding to the recognition result and extract keywords from the analysis result thereof. These databases and dictionary files may be dedicated for the keyword estimation unit 107, or may be commonly used by other processing units.

As hereinabove explained, the keyword estimation unit 107 performs the keyword estimation processing in light of the idea that certain keywords desired to be registered by a user are expected to exist in a content and metadata included in the predetermined time immediately before the time when the trigger was received. Therefore, the keyword estimation unit 107 can automatically extract keywords desired to be registered by a user from among the recognition result provided by the recognition unit 105. Therefore, this saves the user from later searching and registering keywords and the like which the user wants to register.

The buffer 109 is an example of a storage device arranged in the information processing apparatus 10 according to the present embodiment. The buffer 109 may be a RAM and the like arranged in the information processing apparatus 10 according to the present embodiment. The buffer 109 temporarily stores various kinds of keywords which are estimated and extracted by the keyword estimation unit 107 from among the recognition result provided by the recognition unit 105.

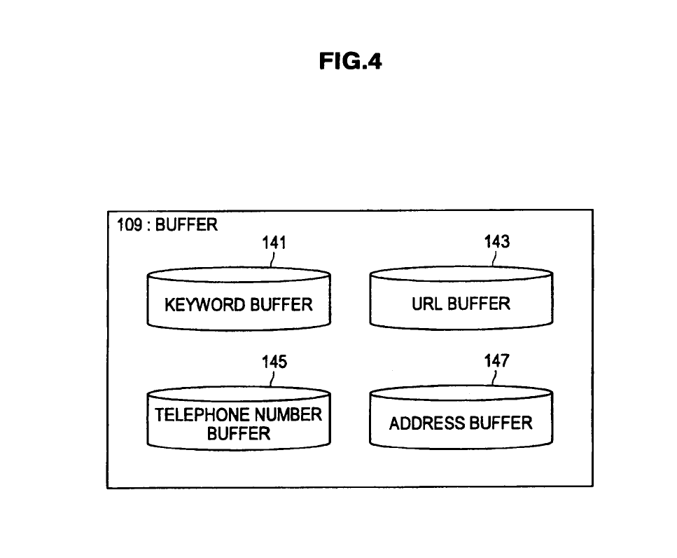

As shown in FIG. 4, this buffer 109 may have separate storage regions each corresponding to a type of keyword. For example, in FIG. 4, examples of separate storage regions include a keyword buffer 141, a URL buffer 143, a telephone number buffer 145, and an address buffer 147.

The keyword buffer 141 is a storage region for temporarily storing various kinds of nouns such as a place name, a person's name, a product name, the name of a food, the name of a facility, and the name of an event. The URL buffer 143 is a storage region for temporarily storing information related to the Internet such as a URL and an E-mail address of a homepage. The telephone number buffer 145 is a storage region for temporarily storing character strings constituted by numbers such as a telephone number and a facsimile number. The address buffer 147 is a storage region for temporarily storing information representing locations such as a zip code and an address.

The buffer 109 as shown in FIGS. 2 and 4 may be arranged for each user of the information processing apparatus 10, or may be commonly used by a plurality of users.

It is to be understood that each buffer as shown in FIG. 4 is merely an example. Each storage region arranged in the buffer 109 of the information processing apparatus 10 according to the present invention is not limited to such example.

The configuration of the information processing apparatus 10 according to the present embodiment will be explained with reference back to FIG. 2.

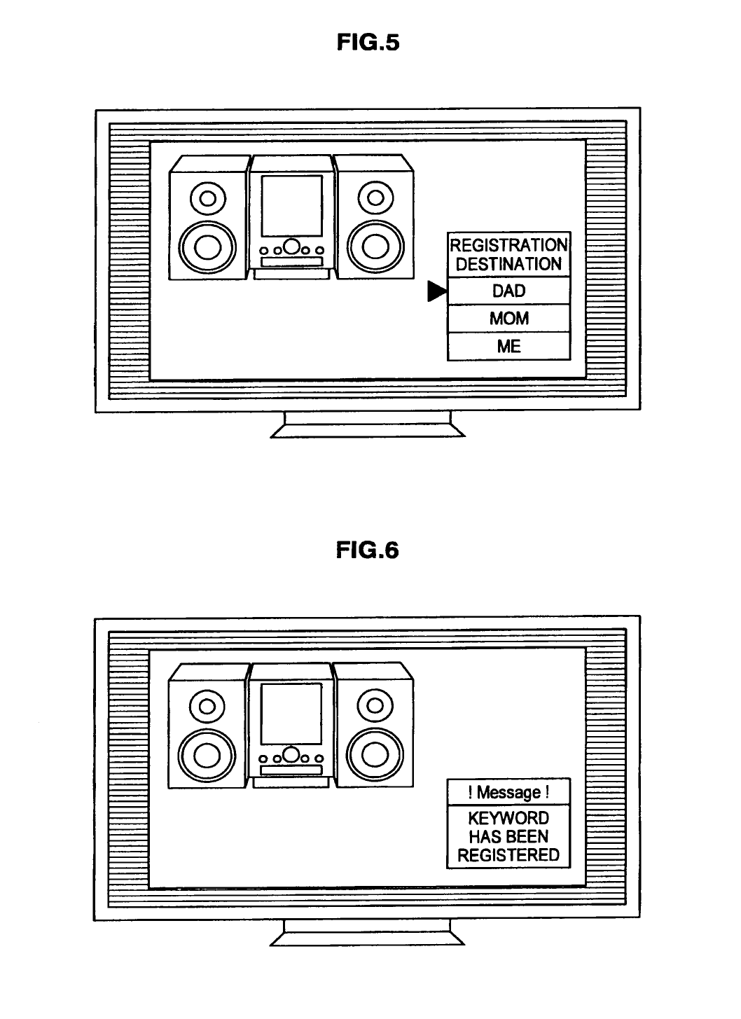

The registration destination selection unit 111 is achieved with, for example, a CPU, a ROM, a RAM, a communication device, and the like. When there are a plurality of registration locations (storage locations) for keywords registered by the later-explained keyword registration unit 113, the registration destination selection unit 111 selects a registration location to which the keyword is to be registered. More specifically, for example, as shown in FIG. 5, the registration destination selection unit 111 displays a message on a display unit (not shown) such as a display arranged on the information processing apparatus 10 or a display unit of the content view apparatus 3 so as to prompt a user to select a registration destination. Thereafter, the registration destination selection unit 111 obtains information corresponding to a selection result (or a signal) provided by a user, and selects a registration location to which a keyword is registered.

The registration destination selection unit 111 outputs information representing the selected registration location to the later-explained keyword registration unit 113.

The registration destination may not be specified. When the registration destination is not specified, a keyword and the like is stored to a default storage location.

The keyword registration unit 113 is achieved with, for example, a CPU, a ROM, a RAM, a communication device, and the like. The keyword registration unit 113 registers the keyword estimated and extracted by the keyword estimation unit 107 to a predetermined registration location (storage location) of the storage unit 121. In a case where the registration destination selection unit 111 specifies the keyword registration location (i.e., in a case where information representing the registration location is notified by the registration destination selection unit 111), the keyword is registered to the registration location specified by the information representing the registration location.

In other words, the keyword registration unit 113 registers not only a keyword extracted from character information but also a keyword extracted from image data and audio data by various kinds of recognition processing (i.e., text data obtained by converting these data) to the storage unit 121.

In this case, when the keyword registration unit 113 registers a keyword extracted from character information and a keyword extracted from image data or audio data and converted into text data, the keyword registration unit 113 registers the keyword upon classifying the keyword according to an attribute of the keyword. In this case, the attribute of the keyword is a classification category obtained by abstracting a specific keyword. Examples of attributes include a place name, a person's name, a product name, the name of a food, the name of a facility, and the name of an event.

The keywords can be classified based on attribute information recorded together with the keywords in the dictionary files. These dictionary files used for the classification of the keywords may be dedicated for the keyword registration unit 113, or may be commonly used by other processing units.

When the keyword registration unit 113 registers a keyword, the keyword registration unit 113 preferably registers, e.g., a content name, a content provider, and a content genre of a content from which the keyword to be registered has been extracted, and a temporal position in the content from which the keyword has been extracted (for example, a timestamp with respect to the beginning of the content) in association with the keyword. For example, such information can be obtained from metadata including program information such as an EPG associated with the content. When a registration keyword is searched, such information can be used as a search condition in addition to the keyword.

When the keyword registration unit 113 registers a keyword, the keyword registration unit 113 may register not only the keyword converted into text data but also original data from which the keyword has been extracted (for example, image data and audio data), in association with the keyword. Since not only the text data but also the original data are registered together, the information processing apparatus 10 can provide not only the keyword converted into the text but also original data which have not yet been converted into the text data (i.e., image data and audio data) when the information processing apparatus 10 provides the registration keyword.

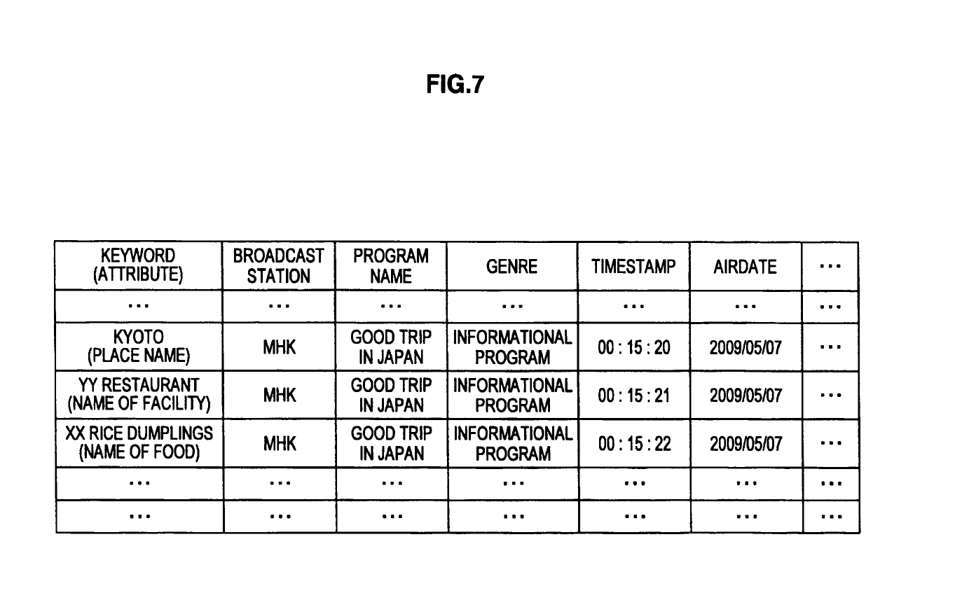

When the keyword registration unit 113 finishes registration of a keyword, the keyword registration unit 113 notifies the later-explained registration information management unit 115 that the new keyword has been registered. For example, as shown in FIG. 6, the keyword registration unit 113 may display a message indicating that the registration of the keyword has been finished on a display unit (not shown) such as a display arranged on the information processing apparatus 10 or on the display unit of the content view apparatus 3. Alternatively, the keyword registration unit 113 may output a sound effect such as a beep sound to notify that a new keyword has been registered. Further, the keyword registration unit 113 may display the registration keyword when this notification is given. When the message is displayed as described above, a user can find that a certain keyword is registered as note information.

The registration information management unit 115 is achieved with, for example, a CPU, a ROM, a RAM, and the like. The registration information management unit 115 manages registration information including registration keywords, which are registered in the storage unit 121 of the information processing apparatus 10.

In other words, when the registration information management unit 115 receives a notification of new keyword registration from the keyword registration unit 113, the registration information management unit 115 requests the later-explained related information obtaining unit 117 to obtain related information related to the new registration keyword. When the registration information management unit 115 receives the related information from the related information obtaining unit 117, the registration information management unit 115 registers the received related information in association with the corresponding registration keyword.

When there is a keyword associated with information representing a time limit (for example, a deadline and an on-sale date), the registration information management unit 115 can automatically remind the user of such information. In a case where the user requests deletion of a registration keyword or in a case where there is a keyword associated with information representing a time limit which is already in the past, the registration information management unit 115 deletes the registration keyword.

In a case where the user performs an operation to cause the information processing apparatus 10 to search and display a registration keyword or in a case where the later-explained information-providing unit 119 requests the registration information management unit 115 to search and display a registered keyword, the registration information management unit 115 searches registration keywords to extract a registration keyword that matches a given search condition, and outputs the extracted keyword.

In this case, information including a keyword stored in the storage unit 121 includes, for example, an airdate, a broadcast station, a genre, a program title, a timestamp, a keyword, related information, and the like as far as they are available. Each piece of the above information can be used as a query to group and sort the information, like a generally-used SQL-based database.

The information managed by the registration information management unit 115 may be reflected in another application. For example, when various kinds of URLs are registered as related information, the registration information management unit 115 can automatically register the URLs to a bookmark of the default Internet browser in the content view apparatus 3, the information processing apparatus 10, the registration information display apparatus 20, and the like.

In the below explanation, the registration keyword and the later-explained related information are collectively referred to as registration information.

The related information obtaining unit 117 is achieved with, for example, a CPU, a ROM, a RAM, and the like. When the registration information management unit 115 requests the related information obtaining unit 117 to obtain related information related to a new registration keyword, the related information obtaining unit 117 obtains the related information by using the information search server 7 and the GPS 9 via the network 5. Alternatively, the related information obtaining unit 117 may obtain the related information by using not only the information search server 7 but also, for example, a service providing server for attaching meta-information to TV contents.

Examples of related information obtained by the related information obtaining unit 117 include URLs of a homepage, a blog, word-of-mouth information, an E-mail address, and the like, position information such as an address, latitude/longitude, a map, and the like, a telephone number, a facsimile number, an RSS, and the like, corresponding to a keyword. The related information obtaining unit 117 notifies obtained information among related information as listed above to the registration information management unit 115. In a case where the related information obtaining unit 117 successfully obtains one of an address and latitude/longitude but fails to obtain the other of the address and latitude/longitude, the related information obtaining unit 117 may generate the other of the information from the obtained one of the information.

The information-providing unit 119 is achieved with, for example, a CPU, a ROM, a RAM, a communication device, and the like. In a case where the user performs an operation to search and display registration information or in a case where the registration information display apparatus 20 requests the information-providing unit 119 to search and provide registration information via the network 5, the information-providing unit 119 requests the registration information management unit 115 to search and extract the registration information. When the information-providing unit 119 receives the extracted registration information from the registration information management unit 115, the information-providing unit 119 displays the registration information on the display unit of the information processing apparatus 10 or the display unit of the content view apparatus 3, and provides the registration information to the registration information display apparatus 20 having transmitted the request.

In this case, the information-providing unit 119 can also provide the keyword converted into the text data as registration information, and provide original data from which the keyword has been extracted (for example, character information, image data, and audio data) as registration information.

When the information-providing unit 119 provides registration information to an apparatus arranged outside of the registration information display apparatus 20 and the like, it is preferable for the information-providing unit 119 to use a standard format such as HTML, Java (registered trademark), and the like, to write registration information and a script to be provided. Accordingly, a network-connectable apparatus such as a personal computer, a portable telephone, and a car navigation system can easily display the registration information.

The storage unit 121 is an example of a storage device arranged in the information processing apparatus 10 according to the present embodiment. The storage unit 121 stores keywords estimated and extracted by the keyword estimation unit 107 and related information related to the keywords.

The storage unit 121 may store various kinds of history information such as history information about keyword registration. Further, the storage unit 121 may store various parameters or progress of processing that are necessary to be stored while the information processing apparatus 10 according to the present embodiment performs a certain processing, and may store various kinds of databases and so on as necessary.

This storage unit 121 can be freely read and written by each processing unit of the information processing apparatus 10.

In the above explanation, the keywords and the related information are stored in the storage unit 121 of the information processing apparatus 10. Alternatively, the keyword and the related information may be stored in the content view apparatus 2, or may be stored in an external apparatus connected via the network 5.

An example of functions of the information processing apparatus 10 according to the present embodiment has been explained hereinabove. Each of the above constituent elements may be made with a generally-used member and circuit, or may be made with hardware dedicated for the function of each constituent element. Alternatively, all of the functions of the constituent elements may be performed by a CPU and the like. Therefore, the used configuration may be changed as necessary in accordance with the state of art at the time when the present embodiment is carried out.

It is possible to make a computer program for realizing the functions of the above-described information processing apparatus according to the present embodiment, and the computer program can be implemented on a personal computer and the like. Further, a computer-readable recording medium storing such computer program can be provided. Examples of recording media include a magnetic disk, an optical disk, a magneto-optical disk, and a flash memory. Further, for example, the above computer program may be distributed by a network, without using any recording medium.

### <Specific Examples of Keyword Estimation Processing, Keyword Registration Processing, and Registration Information-Providing Processing>

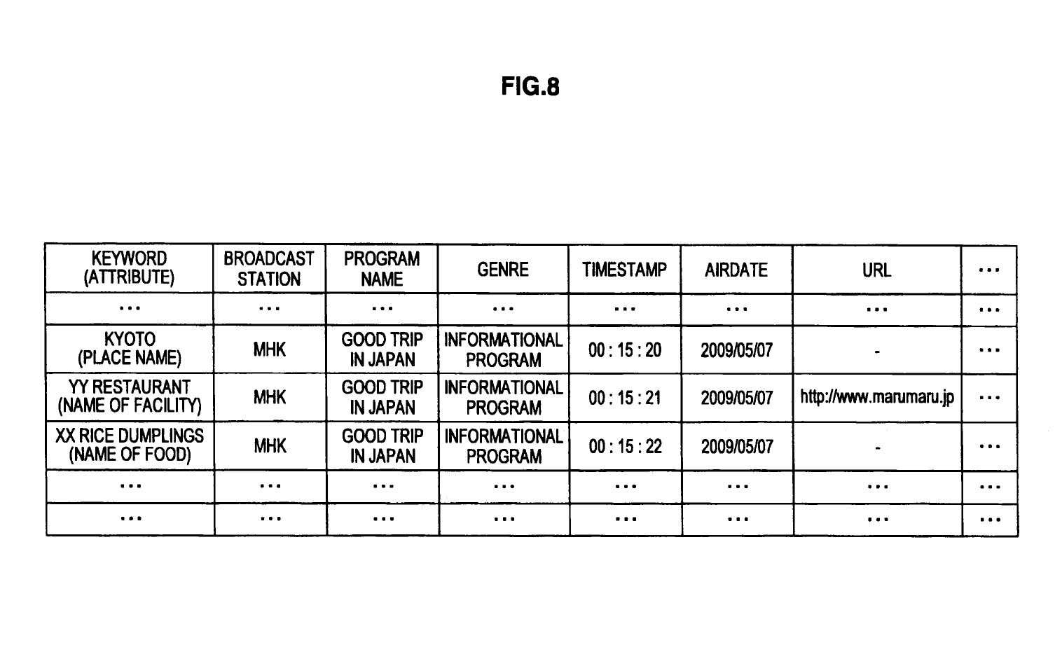

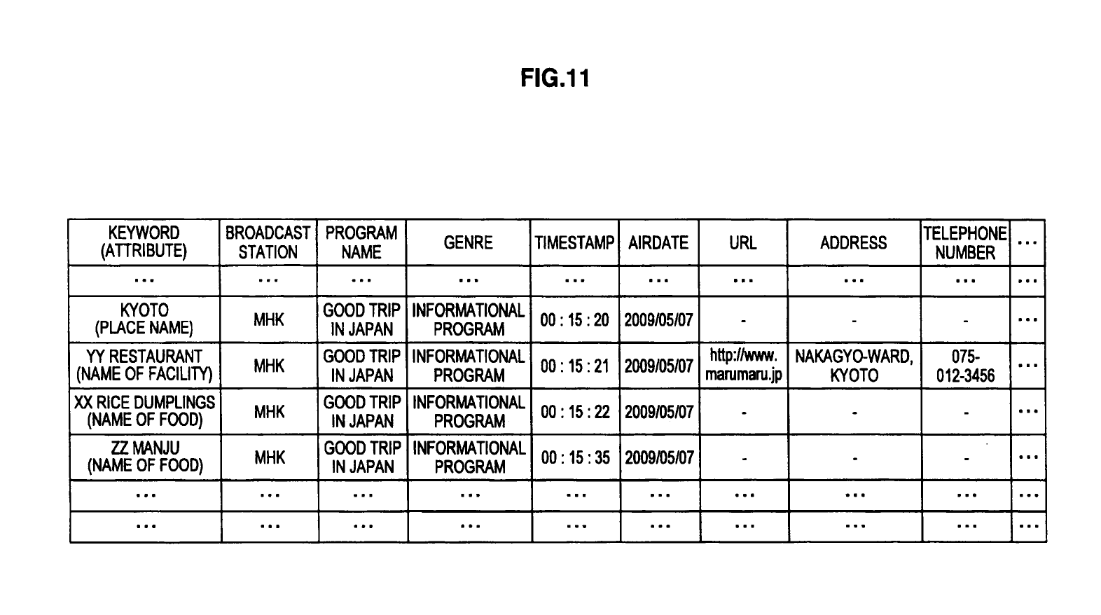

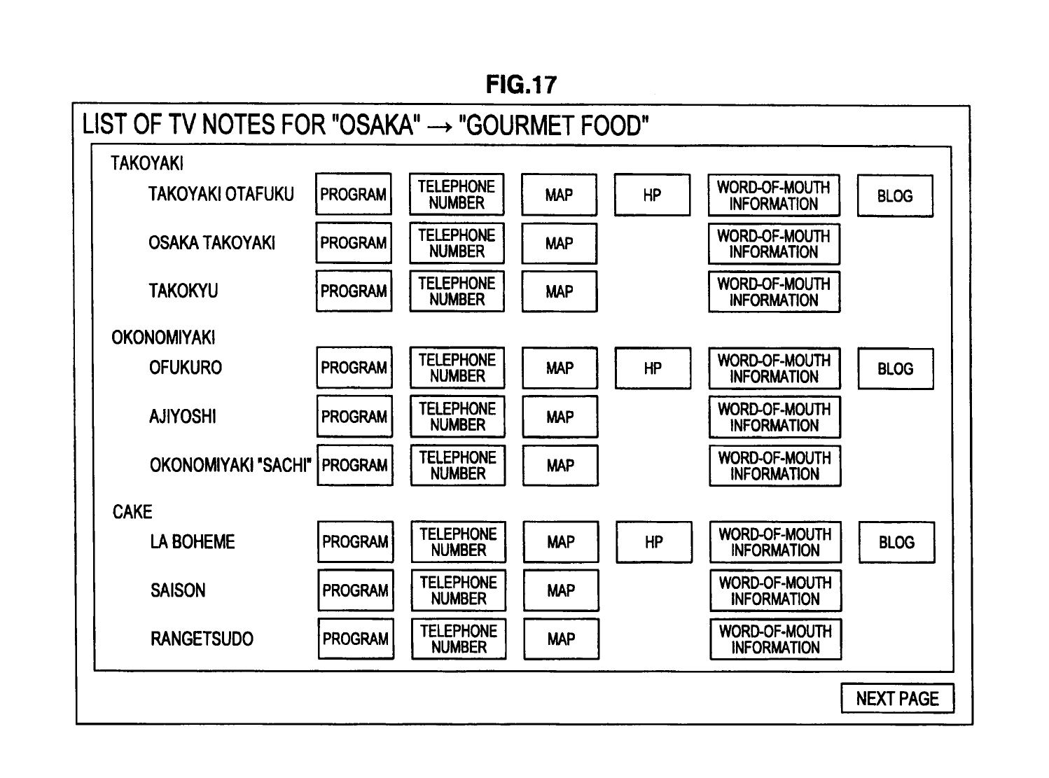

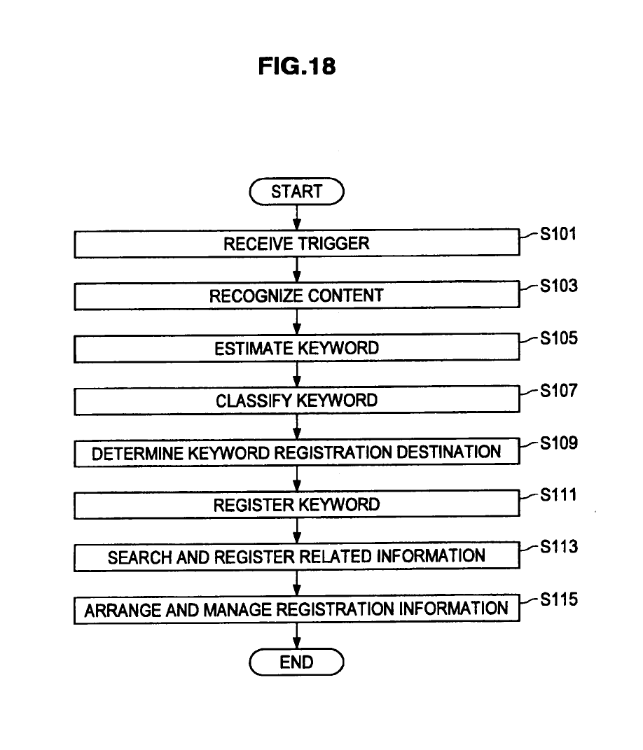

Subsequently, keyword estimation processing, keyword registration processing, and registration information-providing processing carried out by the information processing apparatus 10 according to the present embodiment will be explained with reference to FIGS. 7 to 17 in a more specific manner. FIGS. 7 to 9 are explanatory diagrams illustrating information stored in a buffer. FIGS. 10 to 15 are explanatory diagrams illustrating registration information according to the present embodiment. FIG. 16 is an explanatory diagram illustrating an example of a category selection screen according to the present embodiment. FIG. 17 is an explanatory diagram illustrating an example of a display screen of a search result according to the present embodiment.

### [Specific Examples of Keyword Estimation Processing and Keyword Registration Processing]

First, specific examples of keyword estimation processing and keyword registration processing will be explained with reference to FIGS. 7 to 15.

In the below explanation, it is assumed that, first, a performer in a TV program says “in this season, XX rice dumplings are very popular in this YY restaurant in Kyoto”, and at this occasion, a user of the content view apparatus 3 presses down a note button of a remote controller to give an instruction for starting keyword estimation/registration processing.

In this case, the content obtaining unit 101 of the information processing apparatus 10 obtains a corresponding content, and outputs the content to the recognition unit 105. The trigger reception unit 103 receives a trigger transmitted when the user presses the note button of the remote controller, and notifies the trigger to the recognition unit 105.

The recognition unit 105 traces the content backward for the predetermined time from the time when the trigger was received, and starts recognition of the content. Then, the recognition unit 105 outputs a recognition result to the keyword estimation unit 107. The keyword estimation unit 107 uses the notified recognition result to perform keyword estimation processing and keyword extraction processing. In this case, the keyword estimation unit 107 estimates and extracts keywords, i.e., “Kyoto (place name)”, “YY restaurant (the name of a facility)”, and “XX rice dumplings (the name of a food)”, and stores the keywords to the keyword buffer 141 of the buffer 109. As a result, the contents as shown in FIG. 7 are stored to the keyword buffer 141.

The keyword registration unit 113 obtains these keywords stored in the keyword buffer 141, and registers, to the storage unit 121, the keywords as well as a timestamp with respect to the beginning of the program, a broadcast station, the title of the program, the airdate, and genre information.

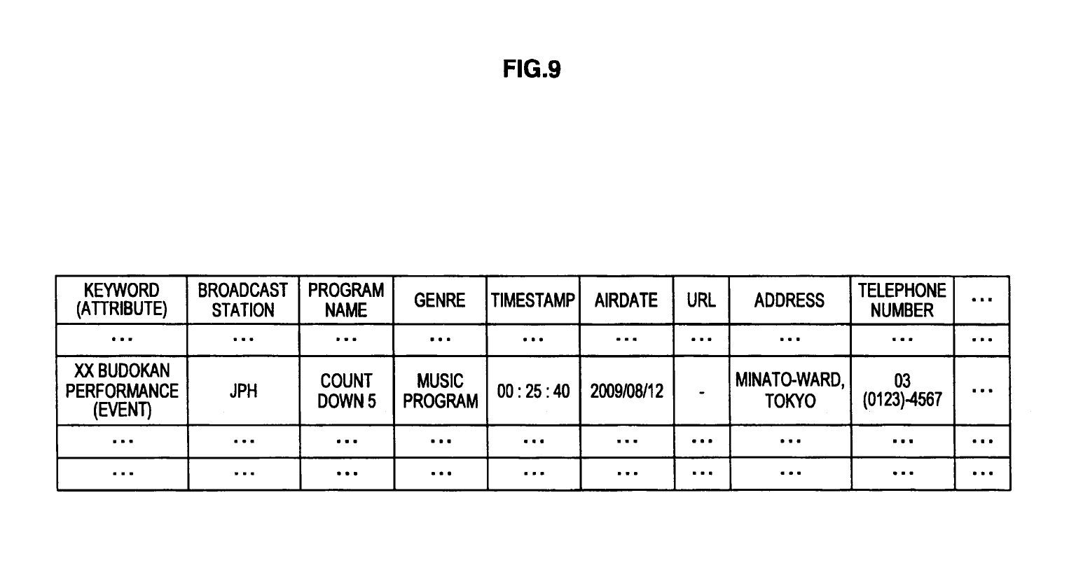

Subsequent to the above words, the performer of the TV program says “this is the URL of this restaurant”, and the URL of the introduced restaurant is displayed as a telop on the display screen. In this case, the URL extraction unit 137 of the recognition unit 105 extracts the URL displayed on the display screen, and stores the URL to the URL buffer 143. As a result, the contents as shown in FIG. 8 are stored to the keyword buffer 141 and the URL buffer 143.

The keyword registration unit 113 obtains these keywords stored in the keyword buffer 141 and the URL buffer 143, and registers, to the storage unit 121, the keywords as well as the timestamp with respect to the beginning of the program, the broadcast station, the title of the program, the airdate, and the genre information.

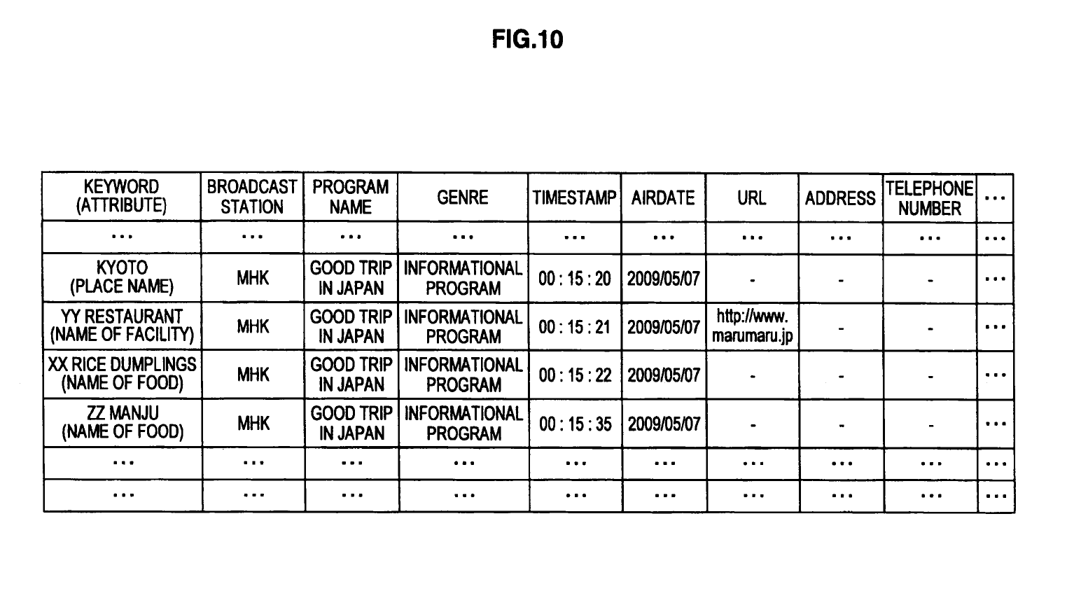

For example, in a music program, a certain concert (held in YY Budokan) is advertized, and a performer or a narrator says “for tickets, please contact here.” When the performer or the narrator says these words, the title of the concert and an address and a telephone number of a ticket office are displayed on the display screen as a telop or a flip card held by the performer. In this case, the URL extraction unit and each recognition unit of the recognition unit 105 extracts a series of information such as a keyword, a broadcast station, a program title, a genre, a timestamp, an airdate, an address, a telephone number, and stores extracted information to the buffers suitable for the information. As a result, the contents as shown in FIG. 9 are stored to the keyword buffer 141, the telephone number buffer 145, and the address buffer 147.

The keyword registration unit 113 obtains these keywords stored in the keyword buffer 141, the telephone number buffer 145, and the address buffer 147, and registers, to the storage unit 121, the keywords as well as the timestamp with respect to the beginning of the program, the broadcast station, the title of the program, the airdate, the genre information.

As a result of the processing as described above, the registration keyword and the related metadata as shown in FIG. 10 are registered to the storage unit 121. As a result, each of the registered keywords is classified based on not only the keyword itself but also the broadcast station, the genre, the airdate, the timestamp, and the like.

When a new keyword is registered, the registration information management unit 115 requests the related information obtaining unit 117 to obtain the related information. The related information obtaining unit 117 accesses, via the network 5, apparatuses providing various kinds of search services, including the information search server 7 and the like, so as to obtain available related information for each keyword.

For example, when a telephone number can be searched by accessing the information search server 7, the related information obtaining unit 117 associates the obtained telephone number and the obtained facsimile number with the registered keyword as related information of the registered keyword. When a keyword is a name of a facility or a place name such as a sightseeing spot, the related information obtaining unit 117 accesses the information search server 7 to try to obtain position information such as latitude and longitude, an address, and a map. The related information obtaining unit 117 can use the information search server 7 to obtain not only the URL of a homepage corresponding to a keyword but also the URLs of a blog and word-of-mouth information.

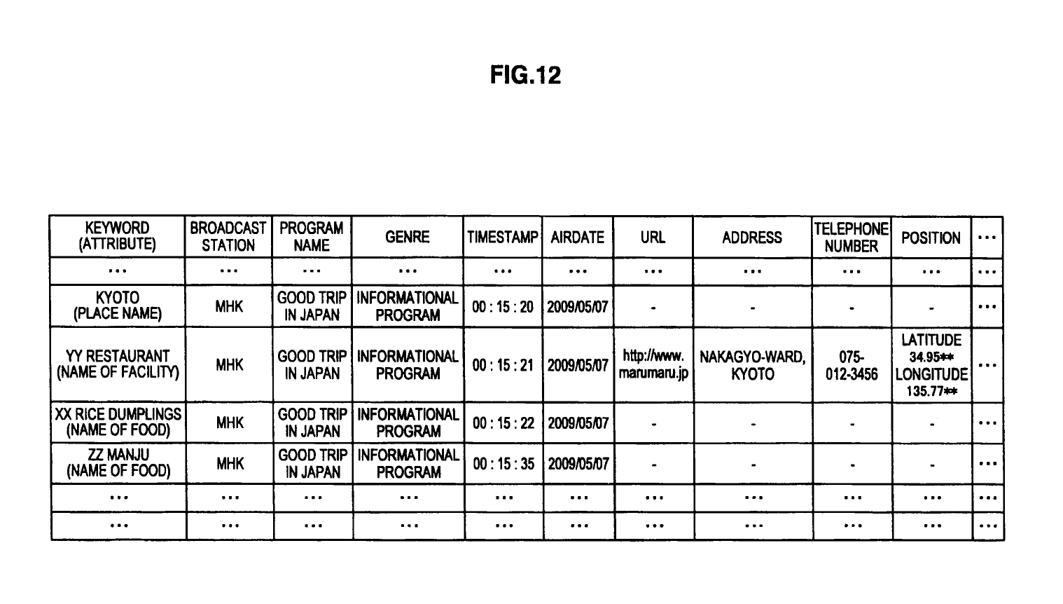

For example, when a telephone number is searched, the related information obtaining unit 117 generates a query such as “keyword, telephone number” to perform search processing using the information search server 7. For example, when there are keywords, i.e., “Kyoto (place name)”, “YY restaurant (proper noun)”, and “XX rice dumplings (proper noun)”, the related information obtaining unit 117 uses the information search server 7 to search “Kyoto YY restaurant XX rice dumplings telephone number.” When the homepage of the “YY restaurant” is found, the related information obtaining unit 117 determines that a numerical string corresponding to a format of a telephone number in a corresponding page is a telephone number of the “YY restaurant.” When the homepage is not found, the related information obtaining unit 117 determines whether the number of obtained search results including “telephone number XXX-XXX-XXXX” is equal to or more than a threshold value. Only when the number of such search results is equal to or more than the threshold value, the related information obtaining unit 117 determines that the obtained numerical string is the telephone number. Further, the related information obtaining unit 117 performs similar processing on the address and the URLs to complement corresponding information. As a result of the above processing, the complemented registration information generated from the obtained related information is stored to the storage unit 121 as shown in FIG. 11.

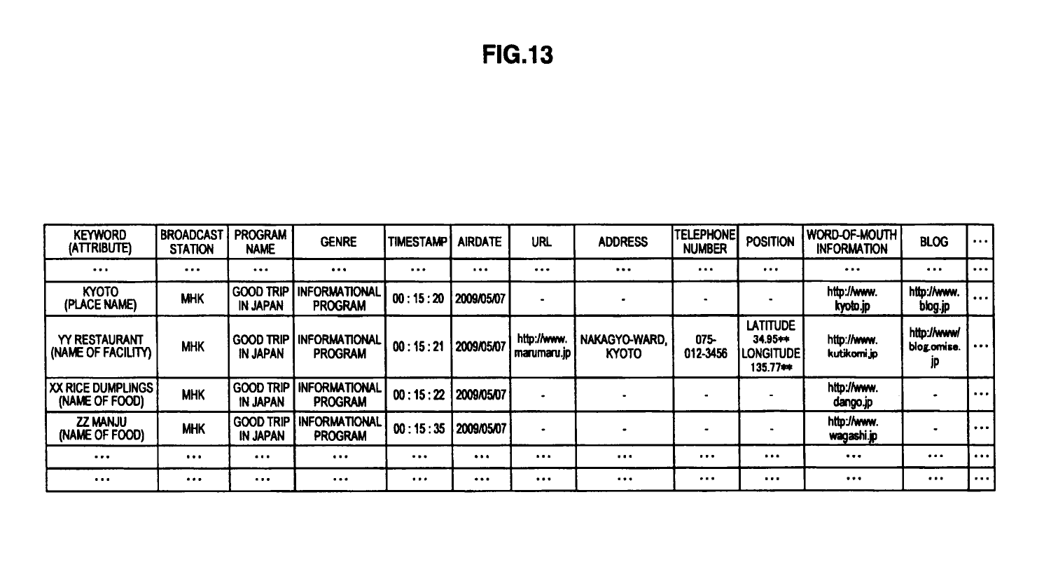

The related information obtaining unit 117 can also use the information search server 7 to obtain position information such as a map and latitude/longitude. For example, the related information obtaining unit 117 can obtain latitude information and longitude information of “YY restaurant” by generating a query such as “Kyoto YY restaurant map” and the like and searching the information search server 7 with the query. As a result of the above processing, the complemented registration information generated from the obtained related information is stored to the storage unit 121 as shown in FIG. 12.

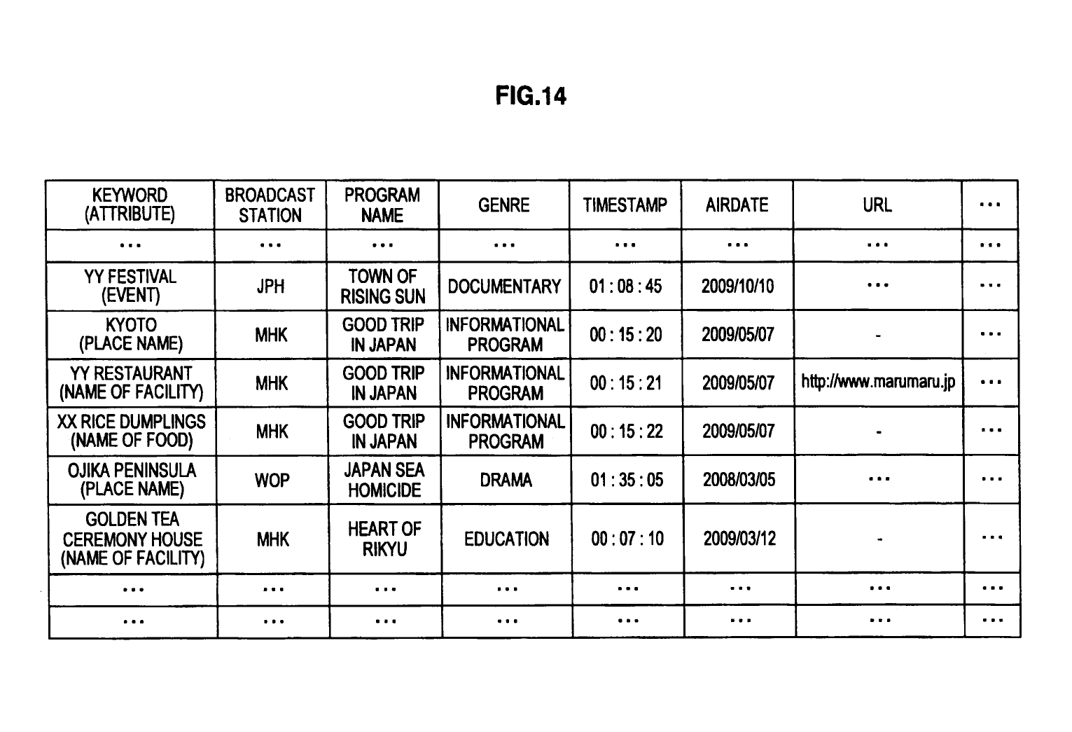

The related information obtaining unit 117 can obtain the URLs of a blog and word-of-mouth information about the registered keyword by performing searches using queries such as “Kyoto YY restaurant XX rice dumplings word-of-mouth” and “Kyoto YY restaurant XX rice dumplings blog.” As a result of the above processing, the complemented registration information generated from the obtained related information is stored to the storage unit 121 as shown in FIG. 13.

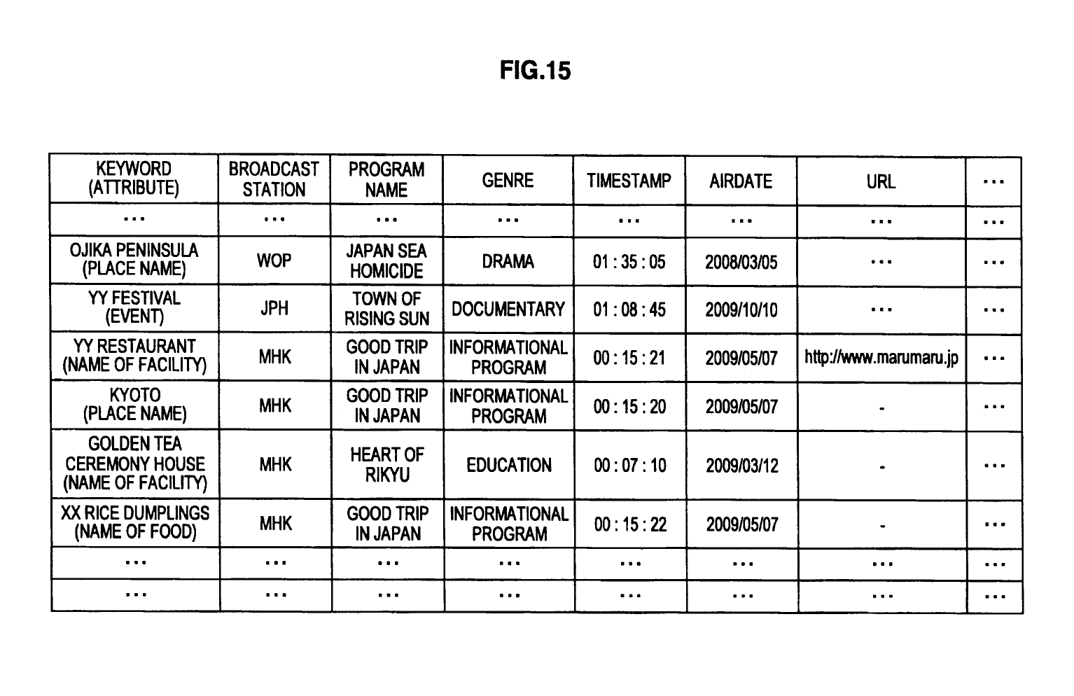

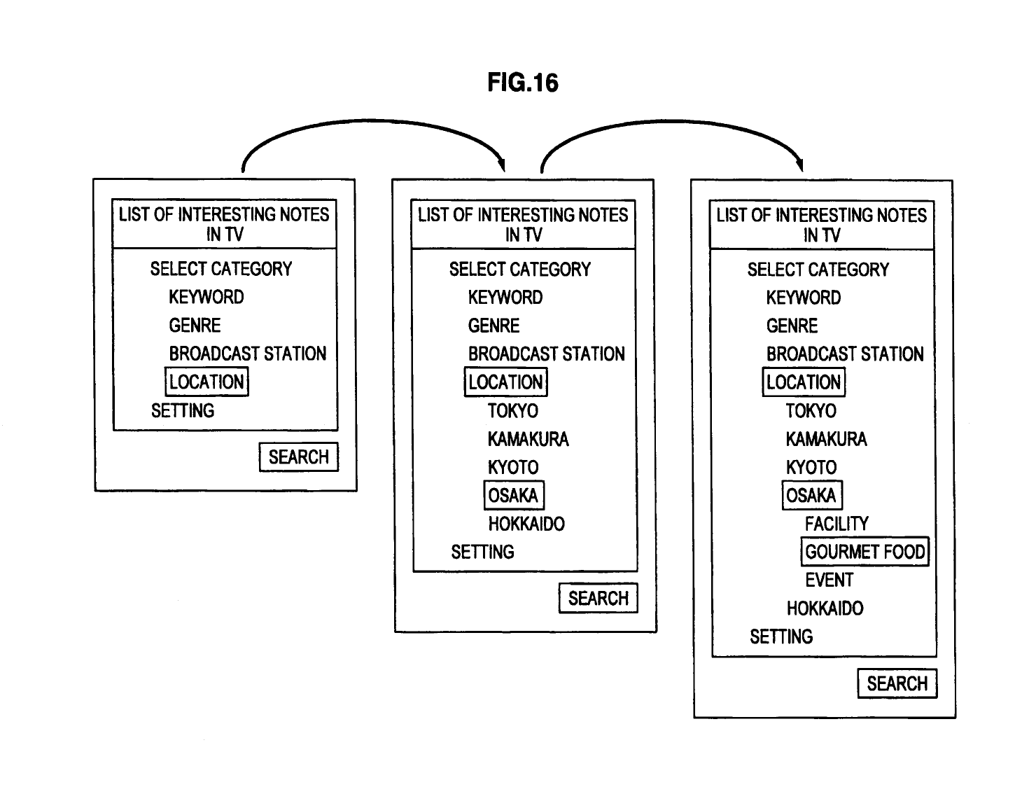

As necessary, the registration information management unit 115 can sort and group the registered information. For example, FIG. 14 shows a case where the registration information management unit 115 sorts the registered information based on the program title. FIG. 15 shows a case where the registration information management unit 115 sorts the registered information based on the keyword.

As described above, in the keyword estimation processing and registration processing according to the present embodiment, keywords desired to be registered by the user are automatically extracted. In addition, information related to the extracted keywords is searched and obtained, and the obtained information is saved in association with the extracted keywords.

### [Specific Example of Registration Information-Providing Processing]

Subsequently, the registration information-providing processing will be explained with reference to FIGS. 16 and 17 in a more specific manner.

In the below explanation, the information processing apparatus 10 provides registration information to the registration information display apparatus 20 connected via the network 5. However, similar processing may be performed even when the information processing apparatus 10 displays registration information on the display unit arranged on the information processing apparatus 10 and the content view apparatus 3.

First, the registration information display apparatus 20 generates a display screen as shown on the left side of FIG. 16 and performs processing for displaying the display screen on a display unit such as a display, in order to transmit a request for viewing registration information registered in the information processing apparatus 10.

First, the registration information display apparatus 20 requests, via the network 5, the information processing apparatus 10 to request information about categories of registered information. When the information-providing unit 119 of the information processing apparatus 10 receives such a request, the information-providing unit 119 causes the registration information management unit 115 to check the categories of registered information, and notifies the categories to the registration information display apparatus 20 via the information-providing unit 119.

The registration information display apparatus 20 can generate a display screen as shown on the left side of FIG. 16 by appropriately arranging information about the categories provided by the information processing apparatus 10 (display category information).

The user of the registration information display apparatus 20 appropriately selects items displayed on the display screen as shown on the left side of FIG. 16, thereby obtaining the display screens as shown in the center and the right side of FIG. 16.

In FIG. 16, display category information appears to be hierarchized. However, the registration information registered in the information processing apparatus 10 and the display category information may not be hierarchized. The registration information display apparatus 20 uses items selected through user operation to search items described in the display category information, thus generating the display screen which appears to be hierarchized as shown in FIG. 16.

In the example as shown in FIG. 16, queries “Osaka” and “gourmet food” are generated as a result of user operation, and the generated queries are transmitted via the network 5 to the information processing apparatus 10.

When the information-providing unit 119 of the information processing apparatus 10 receives the above information search queries from the registration information display apparatus 20, the information-providing unit 119 transmits these queries to the registration information management unit 115. The registration information management unit 115 searches registration information stored in the storage unit 121 based on the obtained queries, and outputs the obtained result to the registration information display apparatus 20 via the information-providing unit 119. In the example as shown in FIG. 16, the registration information management unit 115 combines the keyword “Osaka” (location information) and genre information “gourmet food” to arrange registration information, and obtains the corresponding registration information. Thereafter, the information-providing unit 119 of the information processing apparatus 10 provides the information output by the registration information management unit 115 (search result of the registration information) to the registration information display apparatus 20 via the network 5.

When the registration information display apparatus 20 receives the information provided by the information processing apparatus 10, the registration information display apparatus 20 appropriately arranges the received information to generate a display screen. FIG. 17 is an example of registration information obtained by searching “Osaka” and “gourmet food” as described above. At this occasion, it is preferable for the registration information display apparatus 20 to display the information associated as the related information in a hierarchized manner as shown in FIG. 17.

For example, in FIG. 17, keywords “takoyaki Otafuku”, “Ofukuro”, and “La Boheme” are arranged under the categories “takoyaki”, “okonomiyaki”, and “cake”. Subordinate information to the keywords include related information such as “program”, “telephone number”, “map (location)”, “HP (homepage)”, “word-of-mouth information”, and “blog.”

Any method can be employed as the method for presenting the above related information. For example, an object such as an icon may be displayed to indicate whether corresponding information is available or not. The user of the registration information display apparatus 20 selects these objects, whereby the actual information is displayed in its suitable form.

For example, regarding the telephone number, the registration information display apparatus 20 directly displays the telephone number, e.g., “012-3456-7890”. In a case where the registration information display apparatus 20 is a terminal having a communication function, the user can access a telephone line to call the information by clicking the telephone number.

In a case where the user selects an object representing an HP, word-of-mouth information, and a blog, the registration information display apparatus 20 displays the corresponding HP, the web site including the word-of-mouth information, and the blog, using a default browser usually used by the user in the Internet environment.

When the user selects an object representing a location, the registration information display apparatus 20 can use a map search service provided in the network 5 to display a map showing the location corresponding to address information or latitude/longitude information.

When the user selects an object representing a program, the registration information display apparatus 20 accesses and displays the homepage of the program which the user is interested in and wants to take down a note about. When the HP of the program is displayed, the user of the registration information display apparatus 20 can find how the registered keyword is introduced in the program.

When the registration information display apparatus 20 can communicate with a position detection device such as the GPS 9, the registration information display apparatus 20 can also search registration information by using position information about the current position obtained from the GPS 9, instead of the method for selecting categories as described above.

For example, the registration information display apparatus 20 transmits the position information obtained from the GPS 9 to the information processing apparatus 10. The information-providing unit 119 of the information processing apparatus 10 having received the position information transfers the received position information to the registration information management unit 115. The registration information management unit 115 of the information processing apparatus 10 searches registration information whose registered position information is included within a predetermined range from the position information transmitted from the registration information display apparatus 20 by referencing position information attached to registration information stored in the storage unit 121. Thereafter, the registration information management unit 115 provides the corresponding registration information to the registration information display apparatus 20 via the information-providing unit 119.

As a result, the registration information display apparatus 20 displays registration information located in proximity to the current position, and the user of the registration information display apparatus 20 can search registration information based on position information.

In a case where the registration information display apparatus 20 is, for example, a car navigation system, registration information can be provided in an effective manner by using search processing of registration information using such position information. In other words, the registration information display apparatus 20 (car navigation system) successively transmits position information to the information processing apparatus 10 along a moving path. The information processing apparatus 10 searches registration information based on the received position information, and successively provides the search result to the registration information display apparatus 20. As a result, the user of the registration information display apparatus 20 can efficiently view registration information located along the moving path.

The range, with respect to the received position information, searched for registration information by the registration information management unit 115 of the information processing apparatus 10 may be a value determined in advance by the information processing apparatus 10, or may be any value set by the user. When the search range can be set by the user, the range can be set by operating the information processing apparatus 10, or may be set by operating the registration information display apparatus 20.

In the above explanation, a so-called pull-type information-providing technique has been explained, in which registration information is provided in response to an instruction given by a user. Alternatively, a so-called push-type information-providing technique may be provided, in which the information processing apparatus 10 according to the present embodiment automatically makes determination based on a situation and transmits registration information to a user.

In a case where registration information stored in the storage unit 121 includes a start date/time and an end date/time of an event, and where the current time is already within a range of alert date/time set in advance, the registration information management unit 115 of the information processing apparatus 10 provides information for reminding the approaching end date/time of the event to the registration information display apparatus 20 via the information-providing unit 119.

For example, when registration information about an on-sale date of a ticket of a certain artist is registered in the storage unit 121, the registration information management unit 115 of the information processing apparatus 10 transmits a message, “tomorrow is the on-sale date for an XX concert ticket”, to the user via the information-providing unit 119 on the day before the on-sale date thereof. Likewise, for example, a message, “XX exhibition of YY museum will end this week”, is transmitted to remind the end date. This kind of provision of information can be applied to an on-sale date of a new merchandise, a period in which a movie runs, a time limit for application for giveaways, and various kinds of interesting matters noted in contents.

In this case, the registration information management unit 115 checks an effective period of registered information, and the registration information management unit 115 can automatically delete registration information whose period is already in the past.

When the registration information display apparatus 20 can communicate with a position detection device such as the GPS 9, the registration information display apparatus 20 notifies position information about the current position obtained from the GPS 9 to the information processing apparatus 10. The registration information management unit 115 of the information processing apparatus 10 collates the position information notified by the registration information display apparatus 20 with the position information attached to the registration information stored in the storage unit 121. When the collation result indicates that the position information transmitted from the registration information display apparatus 20 is determined to be close to the position information attached to the registration information, the registration information management unit 115 provides the corresponding registration information to the registration information display apparatus 20 via the information-providing unit 119.

For example, when a user of a portable telephone, i.e., an example of the registration information display apparatus 20, comes close to a restaurant registered in the storage unit 121, the registration information management unit 115 of the information processing apparatus 10 provides a message, “a restaurant having a note is located nearby”, to the portable telephone, i.e., the registration information display apparatus 20.

As described above, with the registration information-providing processing according to the present embodiment, information accumulated as registration information can be referenced by a personal computer in a home, a portable apparatus such as a portable telephone and a car navigation system, and the like. Therefore, a user can make use of notes about visual/audio information anywhere at any time, and enjoys a higher degree of convenience.

### <Flow of Keyword Registration Method>

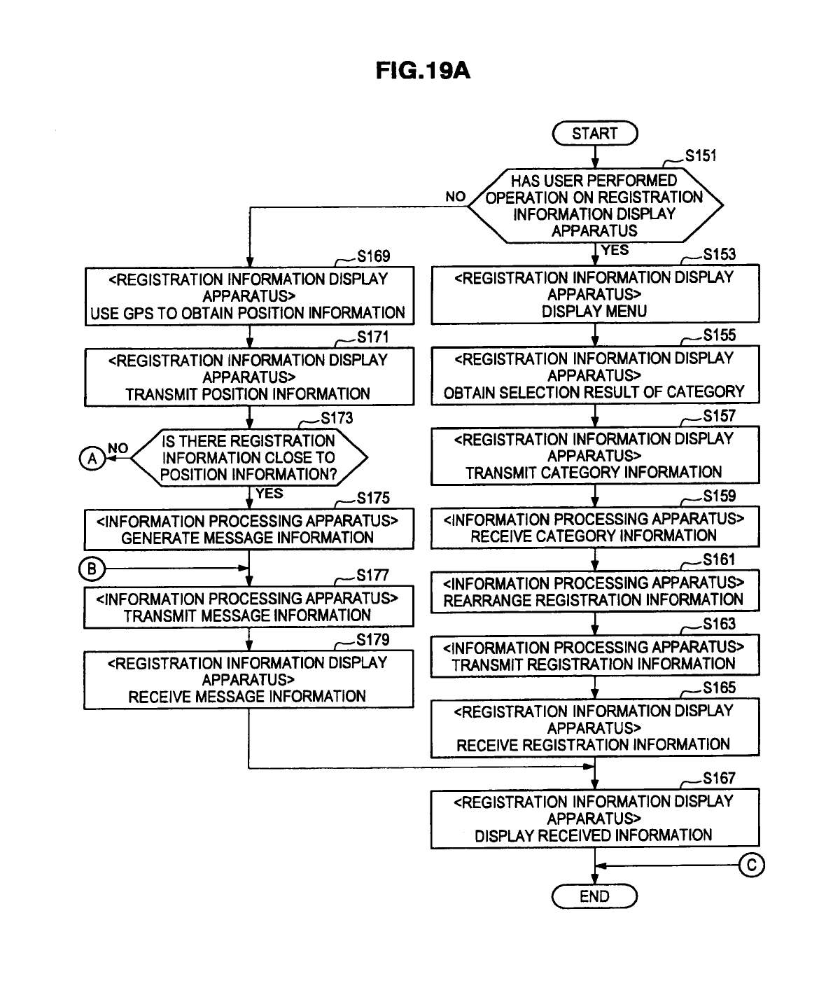

Subsequently, a flow of a keyword registration method performed by the information processing apparatus 10 according to the present embodiment will be briefly explained with reference to FIG. 18. FIG. 18 is a flow diagram illustrating a flow of a keyword registration method according to the present embodiment.

It is assumed that, before the start of the keyword registration method, an interesting topic in a certain program content is provided to a user who is watching the content view apparatus 3, and at that moment, the user transmits a trigger by pressing down a predetermined button of a remote controller or performing a predetermined gesture.

It is also assumed that the content obtaining unit 101 of the information processing apparatus 10 has already obtained entity data of a content being reproduced by the content view apparatus 3 and metadata associated with the content.

When the trigger reception unit 103 of the information processing apparatus 10 receives the trigger given as the predetermined user operation (step S101), the trigger reception unit 103 notifies the reception of the trigger to the recognition unit 105.

When the recognition unit 105 receives the notification indicating the reception of the trigger from the trigger reception unit 103, the recognition unit 105 starts recognition of the content obtained by the content obtaining unit 101 and metadata associated with the content (step S103). When the recognition unit 105 finishes the recognition processing of the content and the metadata, the recognition unit 105 outputs the recognition result to the keyword estimation unit 107.

The keyword estimation unit 107 uses the recognition result provided by the recognition unit 105 to estimate a keyword desired to be registered by the user (step S105). The keyword estimation unit 107 classifies estimated keywords into categories by using the keywords, various kinds of dictionary files, and the like (step S107). The keywords thus estimated and divided are temporarily stored to the predetermined buffer 109.

Subsequently, the keyword registration unit 113 determines a registration destination of the keyword based on information representing a registration location notified by the registration destination selection unit 111 (step S109). As a result, even when the information processing apparatus 10 has keyword registration regions each designated for a certain user, the information processing apparatus 10 can register the keyword to an appropriate registration region. Thereafter, the keyword registration unit 113 registers the keyword temporarily stored in the buffer 109 to the registration destination for the estimated keyword (step S111).

When a new keyword is registered, the registration information management unit 119 requests the related information obtaining unit 117 to search related information (step S113). The related information obtaining unit 117 searches information related to the newly registered keyword to obtain the available related information by using the information search server 7 with which the related information obtaining unit 117 can communicate via the network 5. Thereafter, the related information obtaining unit 117 transfers the obtained related information to the registration information management unit 119. The registration information management unit 119 registers the related information transferred from the related information obtaining unit 117 in association with the corresponding keyword (step S113).

Thereafter, the registration information management unit 119 arranges and manages registration information including the keyword and the related information (step S115), and provides the registration information to the user.

### <Flow of Registration Information-Providing Processing>

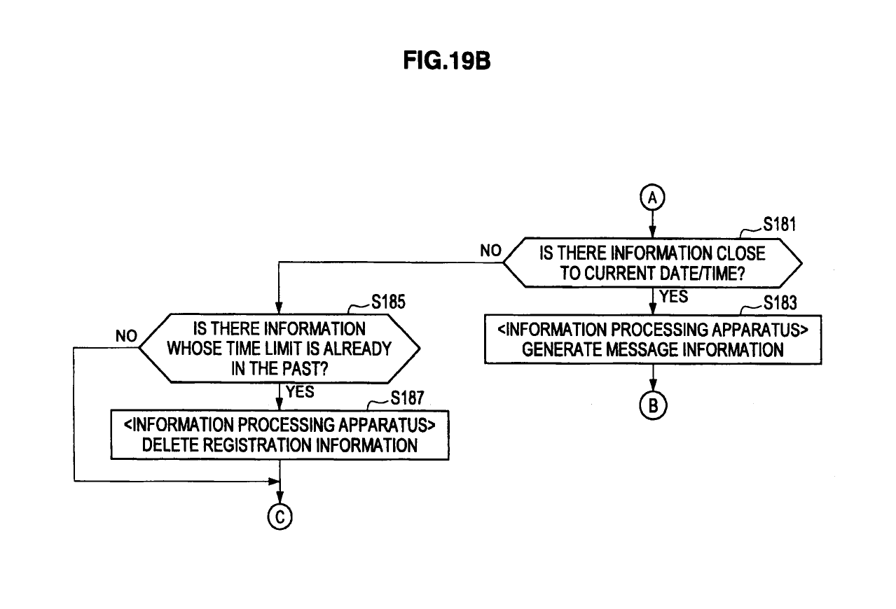

Subsequently, a flow of registration information-providing processing performed by the information processing apparatus 10 according to the present embodiment will briefly explained with reference to FIGS. 19A to 19B. FIGS. 19A and 19B are flow diagrams illustrating a flow of a registration information-providing processing according to the present embodiment.

In the below explanation, the information processing apparatus 10 provides registration information to the registration information display apparatus 20. However, processing can be performed according to a similar flow even when the information processing apparatus 10 provides registration information to the display unit arranged in the information processing apparatus 10 and the content view apparatus 3.

The registration information display apparatus 20 determines whether a user performs a predetermined operation with the registration information display apparatus 20 so as to view registration information or not (step S151).

When the user performs the predetermined operation, the registration information display apparatus 20 performs a predetermined communication with the information processing apparatus 10, and displays a menu screen as shown on the left side of FIG. 16 on the display screen of the registration information display apparatus 20 (step S153).

Subsequently, the registration information display apparatus 20 obtains information about a category selected by a predetermined operation performed by the user (category selection result) (step S155), and transmits the information to information processing apparatus 10 as category information used as a query with which registration information is searched (step S157).

When the information-providing unit 119 of the information processing apparatus 10 receives category information from the registration information display apparatus 20 (step S159), the information-providing unit 119 transfers the received category information to the registration information management unit 115. The registration information management unit 115 uses the received category information to rearrange the registration information (in other words, search of the registration information using the category information) (step S161). Thereafter, the registration information management unit 115 transmits the obtained result to the registration information display apparatus 20 via the information-providing unit 119 (step S163).

When the registration information display apparatus 20 receives the registration information from the information processing apparatus 10 (step S165), the registration information display apparatus 20 appropriately arranges the received registration information, and displays the registration information on the display screen (step S167). As a result, the user of the registration information display apparatus 20 can view the information, registered in the information processing apparatus 10, on the registration information display apparatus 20.

On the other hand, when the user does not perform the predetermined user operation with the registration information display apparatus 20 in step S151, the registration information display apparatus 20 performs the processing explained below. In other words, the registration information display apparatus 20 uses the GPS 9 to obtain position information about the current position (step S169), and the registration information display apparatus 20 transmits the obtained position information to the information processing apparatus 10 (step S171).

When the information-providing unit 119 of the information processing apparatus 10 receives the position information from the registration information display apparatus 20, the information-providing unit 119 transfers the received position information to the registration information management unit 115. The registration information management unit 115 uses the received position information to determine whether there is any registration information associated with position information representing a position close to the received position information (step S173).

When the above position information is determined to be present, the registration information management unit 115 uses the registered keyword and related information to generate message information suitable for the keyword (step S175). For example, when there is registration information of restaurant information located at a position close to the received position information, the registration information management unit 115 generates message information including a message, “a restaurant having a note is located nearby.” Subsequently, the registration information management unit 115 transmits the generated message information to the registration information display apparatus 20 via the information-providing unit 119 (step S177).

When the registration information display apparatus 20 receives the message information from the information processing apparatus 10 (step S179), the registration information display apparatus 20 appropriately arranges the received message information, and displays the received message information on the display screen (step S167). As a result, the user of the registration information display apparatus 20 can view the registration information, automatically transmitted from the information processing apparatus 10, on the registration information display apparatus 20.

When there is no registration information associated with position information representing a position close to the received position information in step S173, the registration information management unit 115 determines whether there is any information having a time limit close to the current date/time (step S181).

When such information is determined to be present, the registration information management unit 115 uses the registered keyword and related information to generate message information suitable for the keyword (step S183). For example, when there is registration information about an on-sale date of a ticket of an artist, the registration information management unit 115 generates message information including a message, “tomorrow is the on-sale date for an YY concert ticket.” Subsequently, the registration information management unit 115 performs the processing of step S177 and subsequent steps explained above.

When there is no information having a time limit close to the current date/time, the registration information management unit 115 determines whether there is any registration information having the time limit which is already in the past (step S185). When such information is determined not to be present, the information processing apparatus 10 terminates the registration information-providing processing. On the other hand, when such information is determined to be present, the registration information management unit 115 deletes the corresponding registration information (step S187), and terminates the registration information-providing processing.

### (Hardware Configuration)

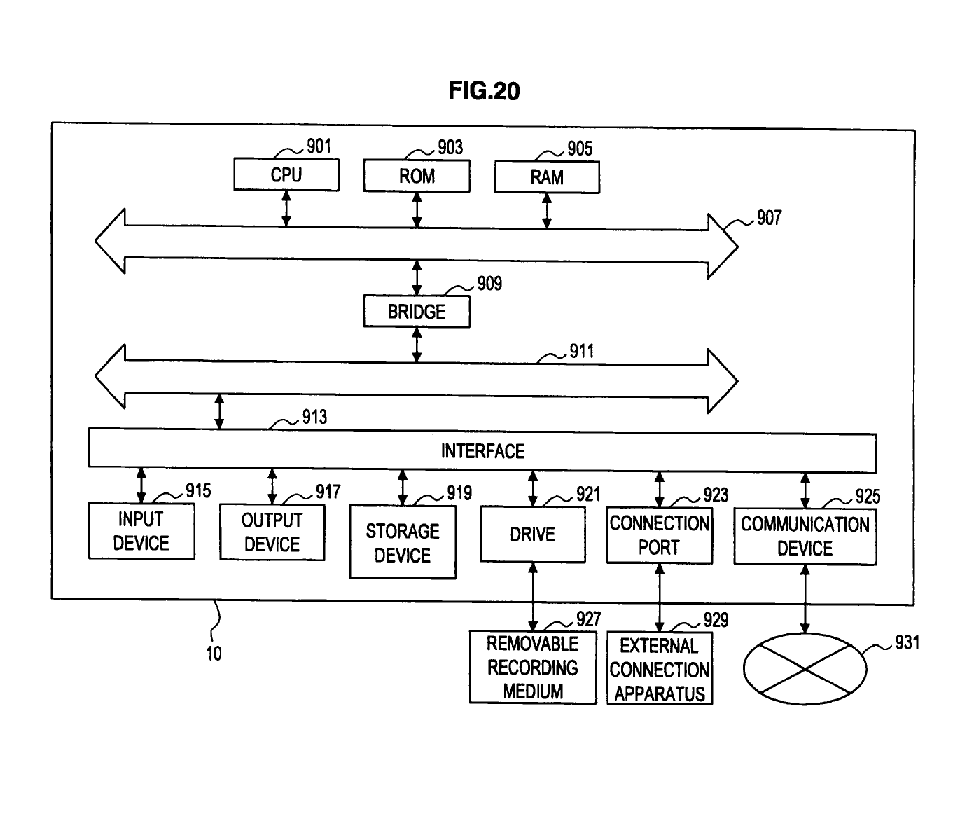

Next, the hardware configuration of the information processing apparatus 10 according to the embodiment of the present invention will be described in detail with reference to FIG. 20. FIG. 20 is a block diagram for illustrating the hardware configuration of the information processing apparatus 10 according to the embodiment of the present invention.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs that the CPU 901 uses and parameters and the like varying as appropriate during the execution of the program. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be configured from a camera and a gesture recognition device. The input device 915 may be a remote control means (a so-called remote control) using, for example, infrared light or other radio waves, or may be an externally connected device 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and acoustic signal data or image signal data, or the like, obtained externally.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains acoustic signal data or image signal data from the externally connected apparatus 929 and provides acoustic signal data or image signal data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication, or the like.

Heretofore, an example of the hardware configuration capable of realizing the functions of the information processing apparatus 10 according to the embodiment of the present invention has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

The hardware configuration of the registration information display apparatus 20 according to the embodiment of the present invention is the same as the hardware configuration of the information processing apparatus 10 according to the embodiment of the present invention. Therefore, detailed description thereabout is omitted.

### (Summary)

In the past, when a user wants to write down the name of an interesting shop, the name of a sightseeing spot, a telephone number, a URL, and the like, while watching a program content on television and the like, it used to be necessary for the user to take down the note using a pen and the like and to obtain the information by himself/herself later. However, as described above, in the embodiment of the present invention, the user can automatically take down a note about interesting information by just performing an operation for transmitting a trigger signal for starting processing. Moreover, information related to a registered keyword (for example, word-of-mouth information, URL, and the like) is automatically registered as a note, which saves the user from searching and viewing information based on the note as in the past. Therefore, this greatly improves the convenience of the user.

Further, position information is automatically registered as related information. Therefore, when a user uses a GPS-enabled communication apparatus, information can be provided according to the current position. As a result, when the user comes close to a location which the user has thought interesting while watching a TV program and the like, the information processing apparatus can automatically provide information to the user.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-042721 filed in the Japan Patent Office on Feb. 26, 2010, the entire content of which is hereby incorporated by reference.

1. (canceled)

2. An information processing apparatus, comprising:
circuitry configured to estimate a keyword desired to be registered by a user based on content within a period of time before when a trigger to register is received and metadata corresponding to the content,
wherein the period of time is changed dynamically based on when the circuitry identifies the keyword, and
the keyword is registered.

3. The information processing apparatus according to claim 2, wherein the circuitry is further configured to obtain information related to the keyword from an external sever, and
the related information is registered in association with the keyword.

4. The information processing apparatus according to claim 2, wherein the keyword specifies an attribute including at least one of a location, a person, a product, and an event.

5. The information processing apparatus according to claim 2, wherein the information processing apparatus includes at least one of mobile phone and a portable navigation device.

6. The information processing apparatus according to claim 5, wherein the trigger is transmitted by a user of the mobile phone.

7. The information processing apparatus according to claim 2, wherein the circuitry is further configured to estimate the keyword based on performing at least one of a morphological, a syntactic, and a semantic analysis based on the content.

8. The information processing apparatus according to claim 2, wherein the keyword is associated with a limitation specified by a combination of date and time.

9. The information processing apparatus according to claim 8, wherein the circuitry is further configured to receive a reminder related to the limitation.

10. The information processing apparatus according to claim 2,
wherein the circuitry is further configured to estimate the keyword based on electric program guide (EPG) data corresponding to the content.

11. The information processing apparatus according to claim 2, wherein the circuitry is configured to transmit the keyword to be registered.

12. The information processing apparatus according to claim 2, wherein the keyword is registered in association with a temporal position of the keyword with respect to the content.

13. The information processing apparatus according to claim 2, wherein the circuitry is further configured to connect to a network.

14. The information processing apparatus according to claim 5, wherein the circuitry is further configured to automatically display the keyword when a current position of the mobile phone is within a predetermined distance of a position associated with the keyword.

15. The information processing apparatus according to claim 14, wherein the circuitry is further configured to update and transmit the current position of the mobile phone.

16. An information processing method for operating an information processing apparatus, comprising:
estimating, by processing circuitry, a keyword desired to be registered by a user based on content within a period of time before when a trigger to register is received and metadata corresponding to the content,
wherein the period of time is changed dynamically based on when the circuitry identifies the keyword, and
the keyword is registered.

17. The information processing method according to claim 16, wherein the information processing apparatus includes at least one of mobile phone and a portable navigation device.

18. The information processing method according to claim 17, further comprising:
automatically displaying the keyword when a current position of the mobile phone is within a predetermined distance of a position associated with the keyword.

19. A non-transitory computer-readable storage medium having computer readable program codes embodied in the computer readable storage medium that, when executed cause a computer to execute an information processing method for operating an information processing apparatus, comprising:
estimating a keyword desired to be registered by a user based on content within a period of time before when a trigger to register is received and metadata corresponding to the content,
wherein the period of time is changed dynamically based on when the circuitry identifies the keyword, and
the keyword is registered.

20. The non-transitory computer-readable storage medium according to claim 19, wherein the information processing apparatus includes at least one of mobile phone and a portable navigation device.

21. The non-transitory computer-readable storage medium according to claim 20, further comprising:
automatically displaying the keyword when a current position of the mobile phone is within a predetermined distance of a position associated with the keyword.
